(19) United States
(12) Patent Application Publication
(10) Pub. No.: US 2002/0138362 A1
(43) Pub. Date: Sep. 26, 2002

(54) Digital file marketplace

(76) Inventors: Christopher Allin Kitze, Incllne Village, NV (US); Jorg Gregor Schleicher, San Francisco, CA (US)

Correspondence Address: SAWYER LAW GROUP LLP, P O BOX 51418, PALO ALTO, CA, 94303, US

(21) Appl. No.: 09/970,815

(22) Filed: Oct. 3, 2001

Related U.S. Application Data
(60) Provisional application No. 60/277,787, filed on Mar. 21, 2001.

(51) Int. Cl. G06F 17/60

(52) U.S. Cl. 705/26

(57) ABSTRACT

A method and system for providing a digital file marketplace is disclosed. The method and system include allowing content owners to share their digital files on the marketplace for access by consumers, and generating revenue by charging the consumers fees for receiving or opening the digital files. The method and system further include paying a percentage of the revenue to the content owners as royalties. In a further aspect of the present invention, consumers may become affiliates of the marketplace where the unused bandwidth of the consumer's computers is used to deliver the files to other consumers. As an incentive, affiliates are also paid for donating the bandwidth and for referring new consumers to the marketplace.

### CROSS-REFERENCE TO RELATED APPLICATIONS

This application is a continuation-in-part of U.S. patent application No. ______, entitled “Method And System For Generating Revenue In A Peer-To-Peer File Delivery Network” (2060P), filed on Sep. 26, 2001.

### FIELD OF THE INVENTION

The present invention relates to a digital file(s) marketplace, and more particularly to an electronic marketplace for the buying and selling of digital files and a financial model for such a marketplace.

### BACKGROUND OF THE INVENTION

The Internet may be viewed as containing distributed information and centralized information. The distributed information is located throughout the Internet and typically takes the form of domain name servers and IP addresses, for instance. The centralized information is content, such as web pages and files, which is stored on and served by central servers.

Gaining access to such centralized content, however, is becoming increasingly difficult due to growing Internet congestion, limited bandwidth, and increasing file sizes (especially for media rich content). Traditional Internet technologies for distributing content, such as e-mail, streaming media, and FTP, have proven inadequate. E-mail is inadequate because due to the number of email messages and attachments passing through email servers, restrictions are placed on the sizes of emails that restricts what can be sent as attachments. E-mail also has security issues. PGP encryption is available for securing e-mails, but is not widely adopted.

Streaming media has the disadvantages of not working with all file types and is expensive because providers must purchase different software for the various streaming media standards. Streaming media also has not proven to be a reliable transfer method. And FTP file transfers also has disadvantages, which include being technically challenging to most users, and suffering from inefficient file transfers. There are other solutions for distributing content, but they are usually proprietary and do not scale well.

Another problem with distributing centralized content is cost. As file sizes increase, the distribution of content is becoming increasingly expensive for content providers due to metered pricing of used bandwidth. In metered pricing, a content provider's Internet-Service-Provider (ISP) monitors the output of the servers used to provide the content, and charges the content provider 95% of the peak usage even though the average output is much lower. Thus, the cost of distributing content from central servers is one reason why attempts have been made to decentralize content.

Accordingly, what is needed is a method and system for distributing digital files. The method and system should support the buying and selling of the digital files, should be reliable and secure, and should reduce transfer costs. The method and system should further include a financial model that continually generates revenue, while supporting the continued growth of the network. The present invention addresses such needs.

### SUMMARY OF THE INVENTION

The present invention is a method and system for providing a digital file marketplace. The method and system include allowing content owners to share their digital files on the marketplace for access by consumers, and generating revenue by charging the consumers fees for receiving or opening the digital files. The method and system further include paying a percentage of the revenue to the content owners as royalties. In a further aspect of the present invention, consumers may become affiliates of the marketplace where the unused bandwidth of the consumer's computers is used to deliver the files to other consumers. As an incentive, affiliates are also paid for donating the bandwidth and for referring new consumers to the marketplace.

### BRIEF DESCRIPTION OF THE DRAWINGS

FIG. 1 is a block diagram illustrating an electronic marketplace for buying and selling digital files in accordance with a preferred embodiment of the present invention.

FIG. 2 is a flow chart illustrating the process of paying a percentage of the revenue to the content owners as royalties to promote use of the file marketplace.

FIGS. 3A and 3B are block diagrams illustrating a peer-to-peer (P2P) network architecture.

FIG. 4 is a flow chart illustrating a method for generating revenue from the peer-to-peer network.

FIGS. 5A-5D are flow charts illustrating the process for providing secure and reliable file sharing in the peer-to-peer network.

### DETAILED DESCRIPTION

The present invention relates to an electronic marketplace for digital files, and more particularly to a financial model for the digital file marketplace that enhances the growth and revenue generation of the file marketplace. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The present invention provides an electronic marketplace for the buying and selling of digital files, and a financial model for the same. The financial model combines the following features: 1) digital file delivery, 2) revenue generation from billing for both the digital files and the delivery of the digital files, and 3) the payment of royalties to content owners. The financial model also integrates affiliate accounting, whereby users are paid for donating unused bandwidth for file deliveries.

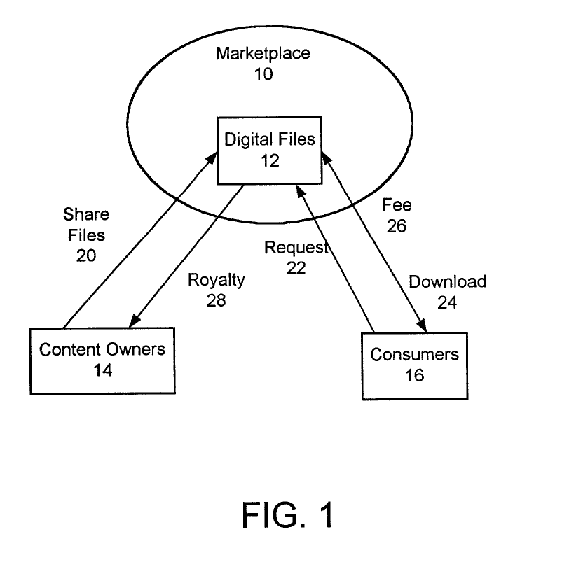

FIG. 1 is a block diagram illustrating an electronic marketplace for buying and selling digital files in accordance with a preferred embodiment of the present invention. In a preferred embodiment, the electronic file marketplace 10 is a website on the Internet that matches the digital files 12 shared by content owners 14 with potential consumers 16. The marketplace 10 supports digital rights management, file and user authentication, and subscription services. According to the present invention, the marketplace 10 also provides content owners 14 with one-stop transaction and royalty accounting capabilities. According to the present invention, content owners 14 may get paid in two ways: from a portion of the collected revenue, based on the popularity of their files 12, and by referring new consumers 16 to the marketplace 10.

In operation, content owners 14 share their digital files 12 by posting the files 12 on the marketplace 10 via step 20. Example type of content files 12 may include audio files 12, video files 12, news articles and online magazines, image files 12, and confidential documents, for instance. And examples of content owners 14 include shareware publishers, musicians, artists and designers. Consumers 16 can search for and request files 12 for downloading via step 22. In a preferred embodiment, consumers 16 may also request a subscription to certain files 12. After the file 12 is downloaded to the user via step 24, the consumer 16 is charged a fee for the file 12 via step 26, which is preferably based on a pay-per-use model. And according to the present invention, a percentage of the revenue collected from the consumers 16 is paid to each of the the content owners 14 as an incentive via step 28 based on the total usage of their respective files 12. In a preferred embodiment, the cost of the bandwidth required to distribute the file is charged to the content owner and is deducted from the royalty paid to the content owner.

As an example of the electronic file marketplace 10, assume that an independent film producer wants to earn money from online distribution, but doesn't have a way to distribute or bill the end user. The producer signs up with the file marketplace 10 and posts his films to the file service. The films join thousands of other media files 12 from other content owners 14 in areas such as, videos, music, ebooks, software, and games. In addition, the publisher can choose to make the films available as a subscription service to subscribers. Assume further that a user logs onto the marketplace 10 and finds one of the films during a search and downloads the film. The user's account would be charged a fee for the file. The producer would be paid a percentage of the revenue collected for that file as a royalty, less any bandwidth and distribution fee charged by the marketplace 10. It is also possible for the producer's files to be made part of a pool of files that users can subscribe to. The producer may also receive a percentage of the total revenue generated from that subscription pool.

Thus, the present invention provides a financial model for the digital file marketplace 10, which includes generating revenue from the delivery of the files 12, and paying royalties to the content owners 14 from the revenue collected, with the remainder of the revenue going to the provider of the digital file marketplace 10. The royalty payments act as an incentive for more content owners 14 to publish content, which will in turn, grow the marketplace 10 and generate further revenue.

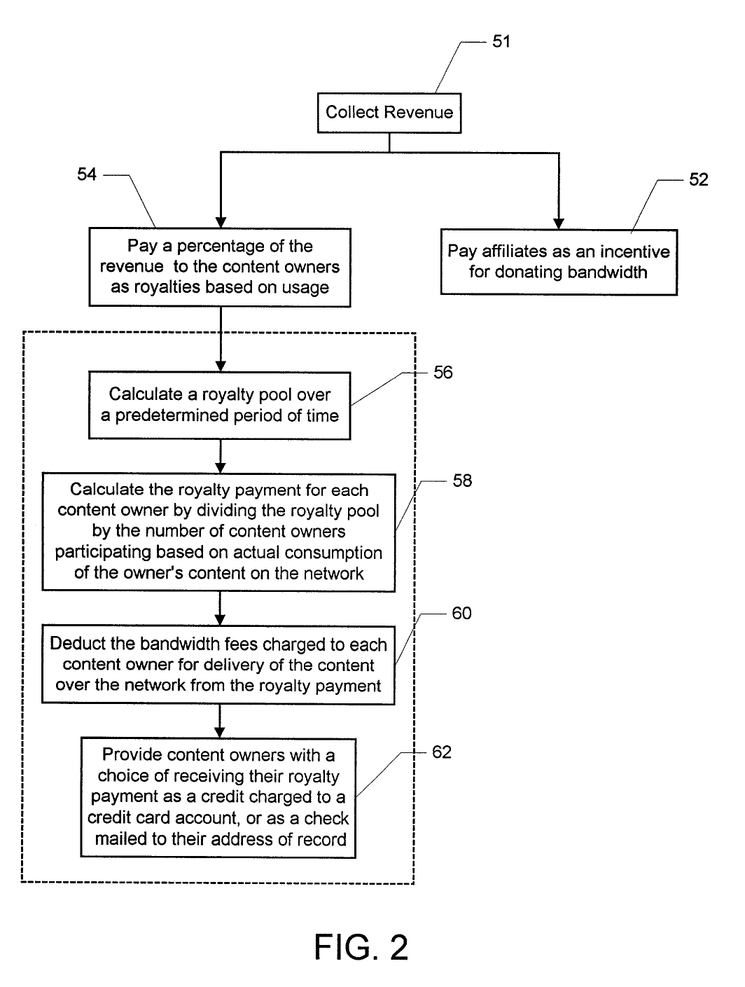

FIG. 2 is a flow chart illustrating the process of paying a percentage of the revenue to the content owners 14 as royalties to promote use of the file marketplace 10. The process begins by collecting the revenue from the fees charged to consumers 16 in step 51. According to the present invention, a percentage of the revenue is paid to the content owners 14 as royalties based on usage in step 54. Paying owners of content royalties should act as an incentive for more consumers 16 to join the marketplace 10 and add content, thereby increasing the growth and income of the marketplace 10. The process of paying royalties is described in steps 56-62.

The first step is to calculate a royalty pool over a predetermined period of time in step 56. In a preferred embodiment, the royalty pool may be determined on a daily, weekly, or monthly basis. After the royalty pool is calculated, the royalty payment for each content owner 14 is calculated in step 58 by dividing the royalty pool by the number of content owners 14 participating during the predetermined time period based on actual consumption of the owner's content on the marketplace 10. In a preferred embodiment, consumption is defined as 1) the number of files 12 delivered, 2) the total size of the content delivered, and/or the money per file paid for the content by consumers 14. After the royalty payments are calculated, the bandwidth fees charged to each content owner 14 for delivery of the files 12 over the marketplace 10 is deducted from the royalty payment in step 60.

The content owners 14 are then provided with a choice of receiving their royalty payment as a credit charged to a credit card account, or as a check mailed to their address of record in step 62. According to the present invention, the marketplace 10 reduces the unauthorized selling of copyrighted contented because it's a fee system and consumers 14 are required to provide a valid credit card number and address that can be verified.

Although the preferred embodiment of the present invention is described in terms of a marketplace website, the present invention may also be implemented as a peer-to-peer network to effectively distribute bandwidth and increase efficiency at which the files 12 are delivered to the consumers 16. In the peer-to-peer network embodiment, consumers 14 may donate unused bandwidth of their computers to the marketplace 10 for the delivery of files 12 to other consumers 14, thereby increasing the bandwidth allocation of the network. Referring to FIG. 2, the affiliates of the network are paid in step 52 as an incentive for donating bandwidth to the network, and for referring new consumers 16 to the marketplace 10.

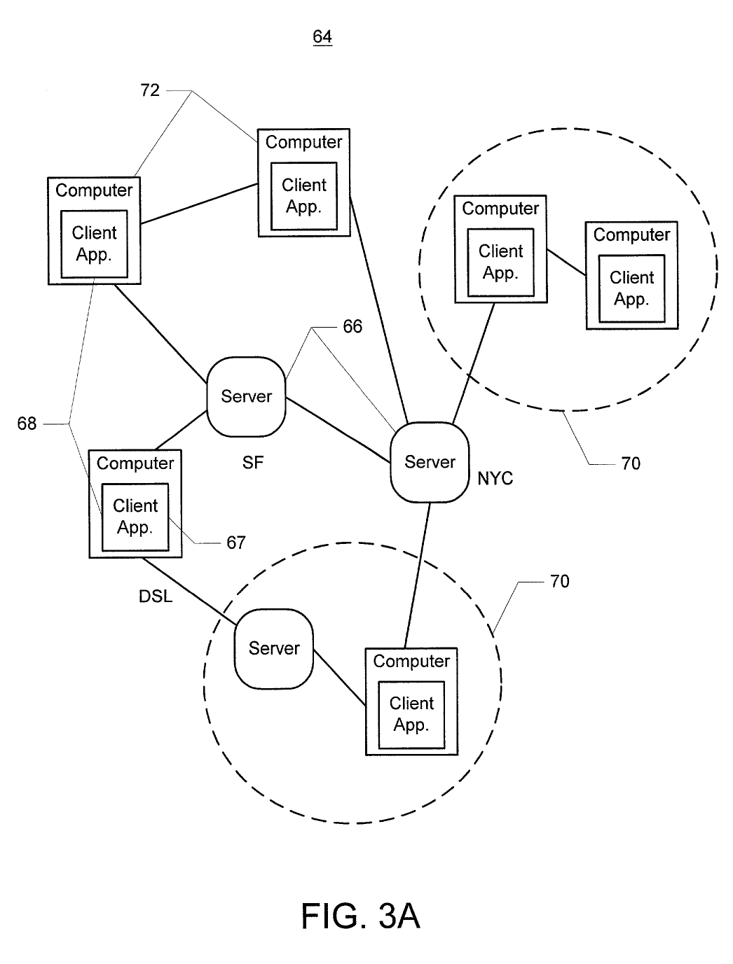

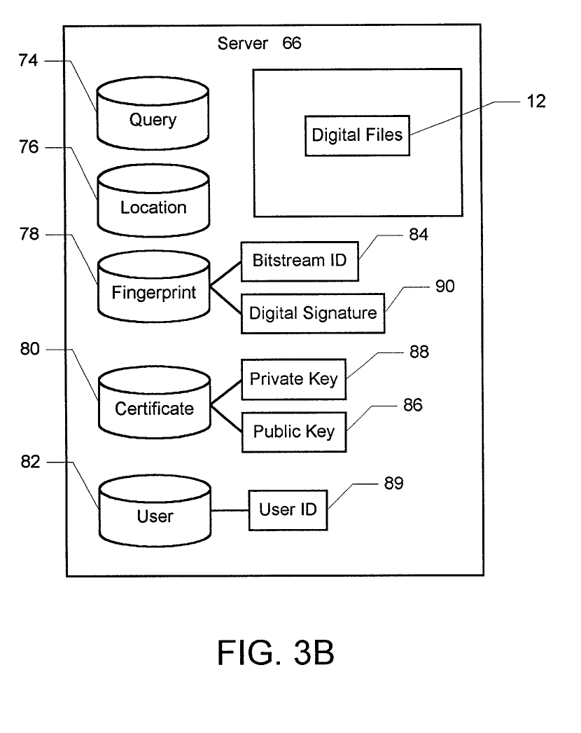

FIGS. 3A and 3B are block diagrams illustrating a peer-to-peer (P2P) network architecture in accordance with one preferred embodiment of the present invention. The peer-to-peer network 64 includes a plurality of computers 72 interconnected over a public network, such as Internet, where some of the computers 72 are configured as server nodes 66, and other computers 72 are configured as client nodes 68. A client node 68 may represent a single computer or a proprietary network, such as AOL, or a cable network, for example, and in a preferred embodiment, the server nodes 66 are located worldwide. The network enables secure and reliable peer-to-peer file sharing between client nodes 68 where consumers 16 may share content using both 1-to-1 and 1-to-many file transfers without the need for going through a server. The network also enables subscription-based decentralized file downloads to the client nodes 68, where consumers 16 may schedule delivery of content over the network.

Any combination of server nodes 66 and client nodes 68 may form extranets 70 that are protected by firewalls (not shown). As is well known in the art, an extranet 70 is basically a private network that uses the public Internet as its transmission system, but requires passwords to gain entrance.

The primary purpose of the peer-to-peer network 64 is the propagation of content over the network. FIG. 3B is a diagram illustrating contents of the server nodes 66. A server node 66 as used herein may refer to any computer that combines hosting services with databases. Although not shown, the marketplace 10 website shown in FIG. 1 includes a server node 66 as described herein. In a preferred embodiment, each server node 66 stores commercial digital files 12 (or access the files 12 from a remote database). Both the content owners 14 and the consumers 16 have a vested interest in secure and reliable delivery of the files 12.

Consumers 14 configure their computers 72 as client nodes 68 by installing and running a P2P client application 67 designed for public networks that operates as described herein. In operation, the client application 67 allows the client node 68 to authenticate other client nodes 68 and to both receive files 12 and serve files 12.

The server nodes 66 facilitate the file sharing process by performing a combination of the following functions. A first function of the server nodes 66 is to process search requests from the client nodes 68 for files 12 and to provide the results. A second function of the server nodes 66 is to aid the client nodes 68 in authenticating other client nodes 68 and file transfers during direct client-node transfers. A third function is content delivery, which includes a) providing subscription-based decentralized file downloads that allow the client nodes 68 to subscribe and automatically receive periodically updated files 12 (push technology), and b) storing files 12 when a client node 68 publishes a file for subsequent delivery to a requester by the server when the publishing node is off-line. A fourth function of the server nodes 66 (and the client nodes) is to serve as proxies to the extranets 70 so that the client nodes 68 inside the extranets 70 can be part of the peer-to-peer network through the extranet 70 firewalls.

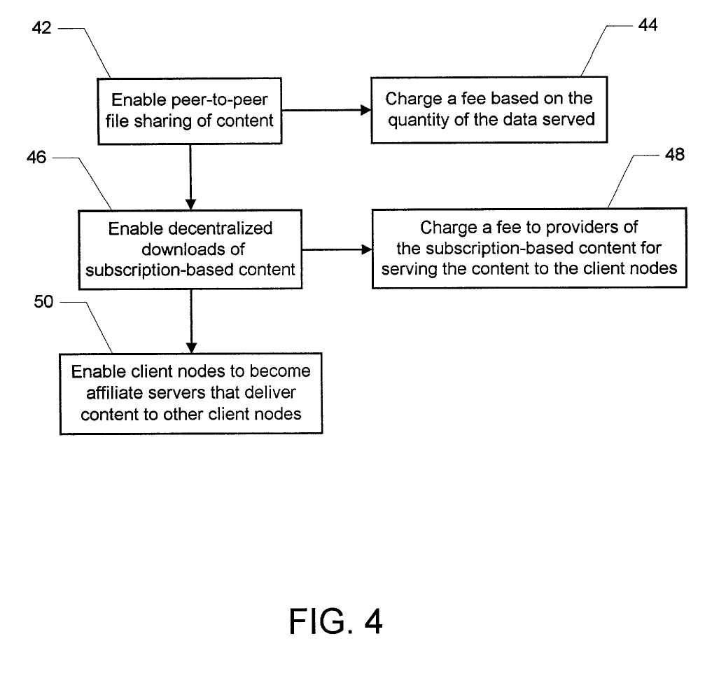

FIG. 4 is a flow chart illustrating a method for generating revenue from the peer-to-peer network in accordance with one preferred embodiment of the present invention. Revenue may be generated from the peer-to-peer network by providing a novel combination of file sharing services. One service provided for generating revenue is enabling peer-to-peer file sharing of files 12 in step 42, and charging a fee based on the quantity of the data served 20 in step 44. As used herein, peer-to-peer file sharing refers to the initiation of a file download by a client node 68 from either the server node 66 or another client node 68. Files 12 made available for downloading in this manner may be referred to as “on demand” because the file 12 is available for downloading by the client nodes 68 at anytime. In a preferred embodiment, on demand file includes both fee-based file and free file. If the file downloaded is free to a consumer, then the content owner 14 of the file 12 may be charged a fee for the serving of the file based on the quantity of the data transferred. If the file 12 downloaded is fee-based, however, then the consumer 14 of the initiating client node 68 may be charged a pay-per-usage fee.

The second service provided for generating revenue in the network is enabling decentralized downloads of subscription-based file in step 46. According to one aspect of the present invention, client nodes 68 may subscribe to one or more of the subscription-based file, and in return, the subscribed to file is periodically sent to each of the respective subscribing client nodes 68 either from the server node 66 or from another nearby client node. Content owners 14 of the subscription-based file are then charged a fee for the delivering the file to the client nodes 68 in step 48.

In a preferred embodiment, the subscription-based file may be made available for free or for a fee (e.g., pay-per-use files 12). If the file if fee-based, then a fee may be charged to the consumers 16 of the subscribing client nodes 68 for receiving or opening the fee-based file. The fee charged to the consumers 16 may be in addition to, or in lieu of, the fee charged to the providers of the subscription-based file. The fee charged to the file providers may be based on a priority level chosen for delivering the particular file, and the quantity of data delivered. A high priority means that the file will be allocated adequate bandwidth to deliver the file within a particular time frame and at the exclusion of other file deliveries if necessary.

The third service provided for generating revenue and the network is enabling owners of client nodes 68 to become affiliates of the marketplace where the unused bandwidth of those client nodes 68 is donated to the network for use in delivering file to other client nodes 68 in step 50. For example, college students that own computers 72 and fast Internet connections may enroll as affiliates, thereby providing the network with additional bandwidth to serve files 12. Faster file delivers over the network should attract new consumers 16 to the network and increase revenue.

As shown in FIG. 3B, in a preferred embodiment of the present invention, each server node 66 includes several databases for implementing the functions described above. The server node 66 includes a query database 74, a location database 76, a fingerprint database 78, a certificate database 80, and a consumer database 32. The query and a location databases 74 and 76 store the names and locations of the files 12 shared on the network, respectively. The fingerprint database 78 stores fingerprint information that has been generated for each file for determining the authenticity of the files 12. The certificate database 80 contains certificate information to certify and verify the authenticity of all consumers 16 of the file network 64. And the consumer database 32 includes account information for the consumers 16 of the client nodes 68.

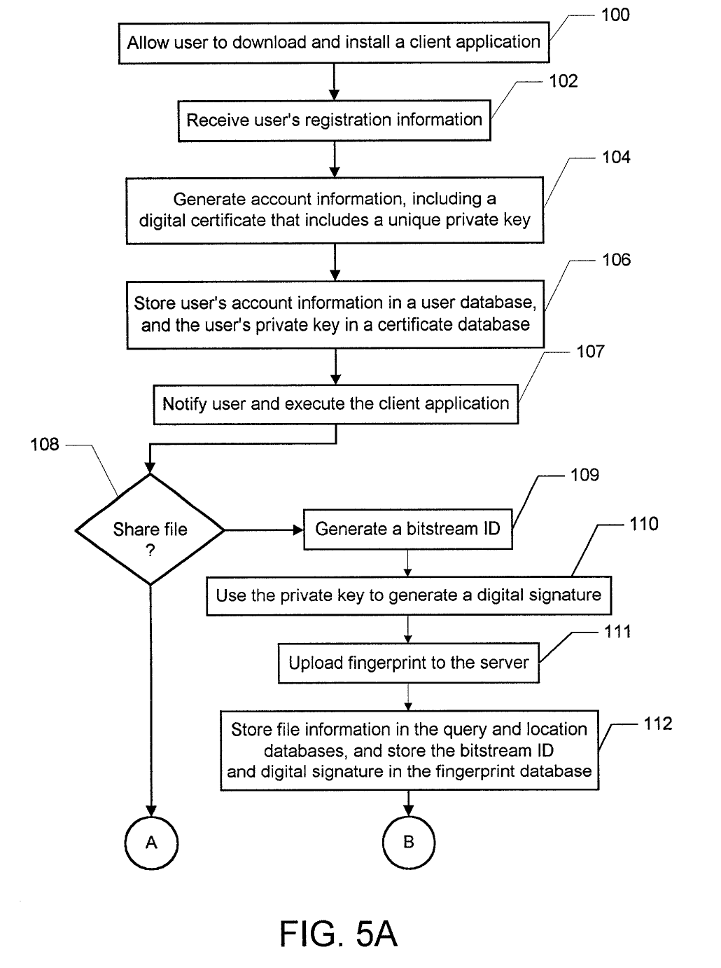

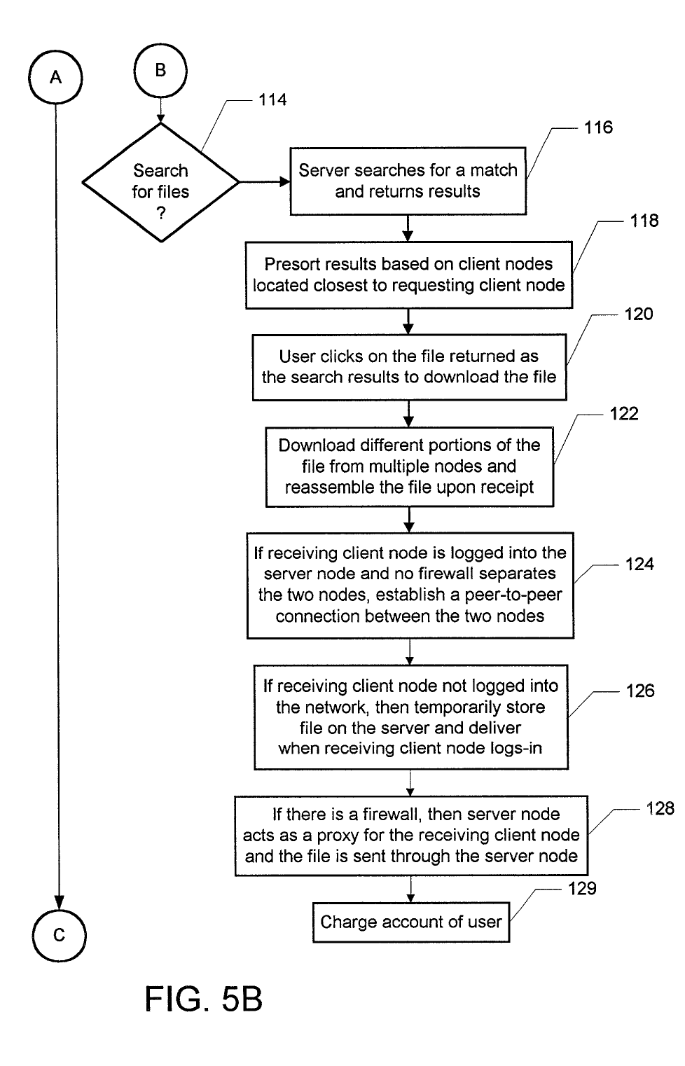

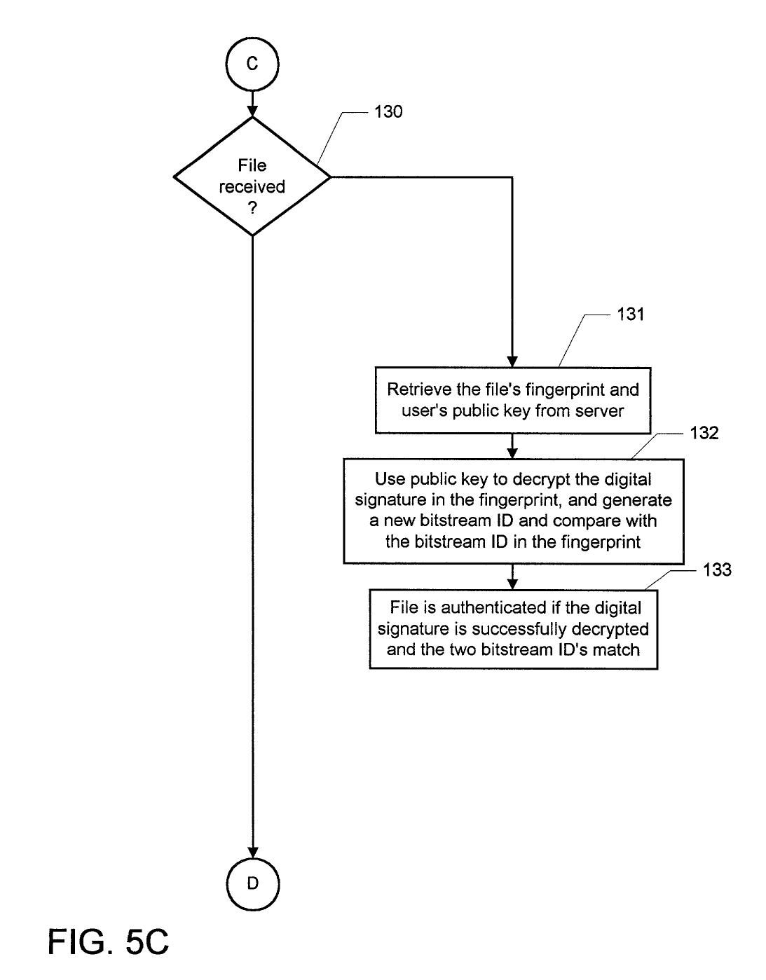

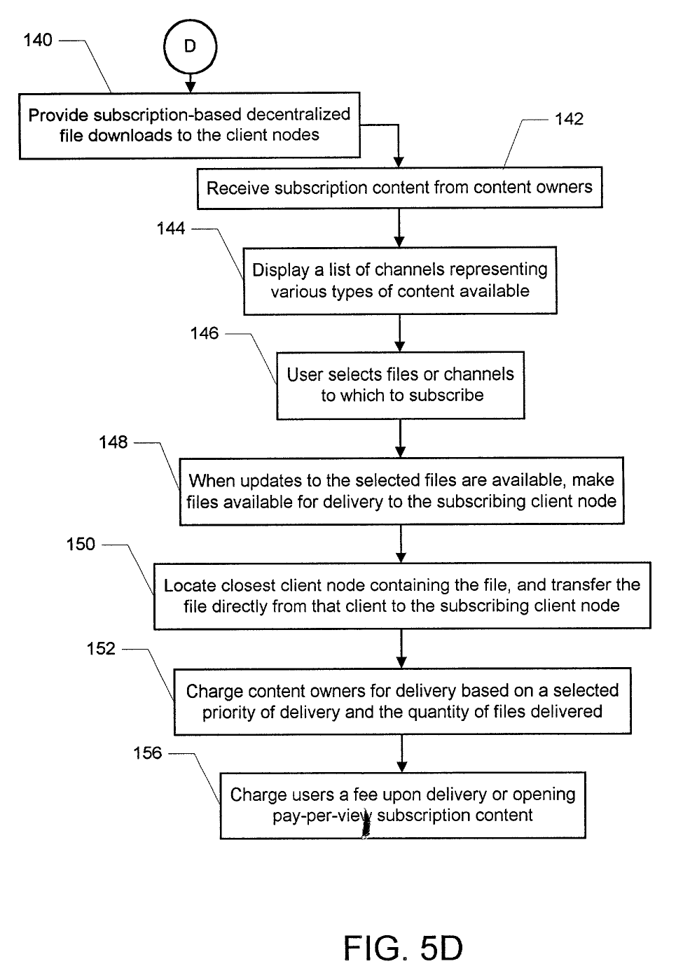

FIGS. 5A-5D are flow charts illustrating the process for providing secure and reliable file sharing in a peer-to-peer network in accordance with a preferred embodiment of the present invention. The process begins by allowing a consumer to become a member of the network by downloading and installing a copy of the P2P client application 67 on the consumer's computer in step 0. In a preferred embodiment, the P2P client application 67 is downloaded from one of the server nodes 66, although the P2P client application 67 may be obtained from other sources.

Next, the server node 66 receives registration information entered by the consumer in step 102, which can include credit card information, home address, e-mail address, and demographic information for direct marketing purposes. In response, the server node 66 generates account information for the consumer, including a digital certificate that includes a public key 86 and a private key 88 in step 104. The consumer's account information, such as the consumer ID 89, is stored in the consumer database 82, and the consumer's public key 86 and private key 88 are stored in the certificate database 80 in step 106. When registration is complete, the consumer is notified and may then execute the P2P client application 67 in step 107. At any point during the registration process, the consumer may be requested to deposit a sum of money to his or her account, which will be used for fee-based file in which the fees are deducted from the consumer's account based on usage.

Once the client node 68 invokes the client application 67, a client application 67 desktop window (not shown) is displayed on the computer in which the consumer may search for files 12 on the network.

Referring to both FIGS. 5A and 5C-5D, the P2P client application 67 allows the consumer to perform four primary functions: share files 12 over the network in step 108, search for a file 12 to download and download the file 12 in step 114, receive files 12 over the network in step 130, , and subscribe to file over the network in step 140.

The content owner 14 may share pre-approved files 12 on the network in step 108 either publicly or privately. In accordance with the present invention, secure file transfers are enabled by creating a fingerprint for each file when the file is published via steps 109-112. Referring to both FIGS. 3B and 5A, first, the P2P client application 67 generates a bitstream ID 84 for the file in step 109. In a preferred embodiment, the bitstream ID 84 is generated by calculating binary values in data blocks of the file itself. The P2P client application 67 then uses the private key 88 to generate a digital signature 90 for the file in step 110. In an alternative embodiment, the private key 88 may also be used to encrypt the bitstream ID. Together, the bitstream ID 84, the file information, and the digital signature 90 form the fingerprint for the file. The fingerprint ensures that the file is transmitted in its original state (data integrity) by the identified consumer/publisher.

After the fingerprint is generated, the fingerprint is uploaded to the server node 66 in step 111 if it matches with a fingerprint in a file authority. The file information is stored in the query and location databases 74 and 76, and the bitstream ID 84 and digital signature 90 are stored in the fingerprint database 78 under an entry for the file in step 112. Preferably, the name of the file is stored in the query database 74, while attributes of the file, such as the identity of the consumer/publisher and the publishing node, the file size, the bit rate of the file, and so on, are stored in the location database 76. After the file fingerprint has been uploaded, the file is ready for transmission over the network 64.

The consumer may also search for files 12 on the network in step 114 by entering search terms. In response, the server node 66 searches for a match for the search terms in the query database in step 116.

In a further aspect of the present invention, instead of just displaying a list of matching file names, the server examines the entries for the files 12 in the location database 76, presorts the matches based on the files 12 that are located closest to the requesting client node, and returns the results in step 118. The criteria for determining the closest client nodes 68 include geographic location, bandwidth speed, and current network traffic. In a preferred embodiment, the server node 66 may return a list of the highest-ranking files 12 to the client node, but only displays the highest-ranking file name to the consumer, rather than a list of redundant files 12. The consumer may then click on the file returned as the search result to have the file downloaded in step 120.

In conventional peer networks, if the file is downloaded from one node to another, and the first node logs-off during the transfer, then file delivery will fail. The present invention further ensures reliable delivery using multiple and partial file transfers. To download a file, the client node 68 downloads different portions of the file from different thus nodes (e.g., downloading ⅓ of the file from three different nodes), and then reassembles the file upon receipt in step 122. If one node goes off-line, an alternate will be selected.

If the receiving client node(s) are logged into the server node 66 and there are no firewalls nodes in step 124, then a peer-to-peer connection is established between the two nodes and the file is sent directly to the receiving node without first going through the server node. If the receiving client node(s) are not logged into the network, then the file may be temporarily stored on the server node 66 and delivered by the server node 66 when receiving client node 68 logs-in in step 126.

If a firewall separates the publishing client node 68 from the receiving client node, then the server node 66 acts as a proxy for the receiving client node 68 and the file is sent through the server node 66 in step 128. In a preferred embodiment, any node in the network may serve as a proxy for a firewall-protected node, as described in U.S. patent application 67 Ser. No. ______, entitled “Method And System For Facilitating File Access From Firewall-Protected Client nodes In A Peer-To-Peer Network, filed on Jan. 31, 2001, and hereby incorporated by reference.

After the file is delivered to the recipient(s), the client account of the consumer who downloaded the file may be charged a fee in step 129.

A file is received by a client node 68 in step 130 after the file has been downloaded in step 134. The client application 67 begins the authentication process by retrieving the fingerprint associated with the file and the consumer's public key from the server node 66 in step 131. Alternatively, the public key may be retrieved from the sender. Please note, that a secure file retrieval is also possible without having the peer application installed on a computer.

The public key is used to decrypt the digital signature 90 in the fingerprint, and a new bitstream ID is generated and compared with the bitstream ID 84 in the fingerprint in step 182. If the digital signature is successfully decrypted and the two bitstream ID's match, then the file is authenticated in step 133. In the embodiment where the bitstream ID is encrypted, the encrypted bitstream ID in the fingerprint must be decrypted with the public key before the comparison. Fingerprinting files 12 as described herein allows the receiving node to determine the authenticity of both the file and the publisher. This doesn't matter much anymore. If you want to add that we can/could do it, that's fine.

In accordance with a further aspect of the present invention, the network also provides subscription-based decentralized file downloads to the client nodes 68, in which a consumer subscribes to files 12 on the network through the P2P client application 67 on a fee and non-fee basis in step 140. The subscription files 12 is received from content owners 14 and authors who contract with the network to deliver the files 12 to consumers 16 in step 142. Examples of content owners 14 and authors include movie studios, software publisher, game publishers, and record lables. The subscription files 12 may include any combination of free subscription file, pay-per-use and subscription file, and marketing file.

In a preferred embodiment, the client application 67 displays a “channels” folder (not shown) containing a list of channels representing various types of file available in step 144. Examples of channels include video channels, news channels, and software updates that are frequently updated and/or subject to new versions. The consumer may then select files 12 or channels to which to subscribe to receive copies of the files 12 in step 146. The files 12 may include any combination of audio, video, text and graphics. Through the subscription feature of the present invention, consumers 16 are provided with the ability to select future versions of file.

When updates to the selected files 12 are available, the files 12 are made available for delivery to the subscribing client node 68 in step 148. In one preferred embodiment, the client node 68 contacts the server node 66 for a list of available files 12 at predetermined time intervals, and then makes a download request for the files 12. In an alternative preferred embodiment, the server node 66 automatically initiates the download.

According to the present invention, to deliver a particular file to a subscribing client node, the server node 66 locates the closest client node 68 containing the file, and the file is transferred directly from that client to the subscribing client node 68 in step 150. Marketing file may be delivered in the same manner. As described above, the closest client node 68 is determined using factors including geographic location, bandwidth speed, and current network traffic. Once the file has been downloaded to the subscribing client node, the file may then be hosted from that client node 68 for other subscribing client nodes 68.

The content owners 14 are charged for delivery based on a priority of delivery they select and the quantity of files 12 delivered in step 152. For pay-per-use and subscription file, the consumer may be charged a fee upon delivery or opening of the file in step 156.

By serving copy of the files 12 peer-to-peer (and through affiliate servers), rather than from the server node 66, the present invention efficiently utilizes unused bandwidth of the client nodes 68. Thus, the present invention utilizes push technology to even out bandwidth distribution by transferring files 12 during off-peak hours to take advantage of idle bandwidth of the client nodes 68. For a worldwide network, this means that at some point during the day, there is always idle network bandwidth available for delivering subscription files 12. Consequently, the present invention greatly reduces bandwidth cost for the network since the files 12 are served directly from client-to-client on a request basis, rather from the server node 66 to all of the client nodes 68. These principles may also be employed when files 12 are pushed from the server nodes 66 12.

The file network of the present invention also allows for the enforcements of copyrights on request. When a third party notifies the network that a particular file is copyrighted and is being copied without permission on network, all references to the file are deleted from the query, location, fingerprint, and certificate databases. Without these references, the file will no longer be available for sharing on the network. In addition, original publishers of copyright infringing file can be tracked. In addition, the financial model for the network allows infringers to be easily identified and located since this information is collected from each consumer in order join the network.

A method and system for providing a financial model for a digital file marketplace that supports the continued growth and income of the network has been disclosed. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1 A method for providing a digital file marketplace, the method comprising the steps of:
(a) allowing content owners to share their digital files on the marketplace for access by consumers;
(b) generating revenue by charging the consumers fees for receiving or opening the digital files; and
(c) paying a percentage of the revenue to the content owners as royalties.

2 The method of claim 1 wherein step (c) further includes the steps of:
(i) calculating a royalty pool over a predetermined period of time; and
(ii) calculating the royalty payment for each content owner by dividing the royalty pool by a number of content owners participating during the predetermined time period based on actual consumption of the owner's content on the network.

3 The method of claim 2 wherein step (c) further includes the step of:
(iii) deducting bandwidth fees charged to each content owner for delivery of the content over the network from the royalty payment.

4 The method of claim 3 wherein step (c) further includes the step of:
(iv) providing the content owners with a choice of receiving their royalty payment as a credit charged to a credit card account, or as a check mailed to an address of record.

5 The method of claim 3 wherein step (c)(i) further includes the step of calculating the royalty pool on one of a daily, weekly, and monthly basis.

6 The method of claim 3 wherein step (c)(ii) further includes the step of defining consumption as at least one of a number of content files delivered, a total size of the content delivered, and money per content file paid for the content by consumers 16.

7 The method of claim 1 wherein the network includes at least one server node and multiple client nodes, step (b) further including the steps of:
(i) enabling peer-to-peer file sharing of content by,
(1) initiating on one client node a download of a particular content item served from the server node or another client node, and
(2) charging a fee based on a quantity of the content served.

8 The method of claim 7 wherein step (b) further includes the step of:
(ii) enabling decentralized downloads of subscription-based content by
(1) allowing the client nodes to subscribe to one or more of the subscription-based content,
(2) periodically sending the subscribed to subscription-based content to each the respective subscribing client nodes, and
(3) charging a fee to providers of the subscription-based content for serving the subscription-based content.

9 The method of claim 7 wherein the content includes free content and fee-based content, step(b)(i)(2) further including the steps of:
1. charging a fee from a provider of the free content for serving the free content, and
2. charging a fee from a user receiving the fee-based content.

10 The method of claim 8 wherein the subscription-based content includes free content and fee-based content, step(b)(ii)(3) further including the step of: charging a fee from consumers 16 of the subscribing client nodes for receiving the fee-based content.

11 The method of claim 1 further including the step of implementing the marketplace as a website.

12 The method of claim 1 further including the step of implementing the marketplace as a peer-to-peer network.

13 The method of claim 12 furthering including the step of:
(d) allowing consumers to become affiliates of the marketplace where the unused bandwidth of the consumer's computers is used to deliver the files to other consumers, and paying the affiliates of the network as an incentive for donating bandwidth to the network.

14 The method of claim 13 furthering including the step of paying the affiliates for referring new consumers to the network.

15 A computer-readable medium containing programming instructions for providing an digital file marketplace, the programming instructions for:
(a) allowing content owners to share their digital files on the marketplace for access by consumers;
(b) generating revenue by charging the consumers fees for receiving or opening the digital files; and
(c) paying a percentage of the revenue to the content owners as royalties.

16 The computer-readable medium of claim 14 wherein instruction (c) further includes the instructions of:
(i) calculating a royalty pool over a predetermined period of time; and
(ii) calculating the royalty payment for each content owner by dividing the royalty pool by a number of content owners participating during the predetermined time period based on actual consumption of the owner's content on the network.

17 The computer-readable medium of claim 16 wherein instruction (c) further includes the instruction of:
(iii) deducting bandwidth fees charged to each content owner for delivery of the content over the network from the royalty payment.

18 The computer-readable medium of claim 17 wherein instruction (c) further includes the instruction of:
(iv) providing the content owners with a choice of receiving their royalty payment as a credit charged to a credit card account, or as a check mailed to an address of record.

19 The computer-readable medium of claim 17 wherein instruction (c)(i) further includes the instruction of calculating the royalty pool on one of a daily, weekly, and monthly basis.

20 The computer-readable medium of claim 17 wherein instruction (c)(ii) further includes the instruction of defining consumption as at least one of a number of content files delivered, a total size of the content delivered, and money per content file paid for the content by consumers 16.

21 The computer-readable medium of claim 14 wherein the network includes at least one server node and multiple client nodes, instruction (b) further including the instructions of:
(i) enabling peer-to-peer file sharing of content by,
(2) initiating on one client node a download of a particular content item served from the server node or another client node, and
(3) charging a fee based on a quantity of the content served.

22 The computer-readable medium of claim 21 wherein instruction (b) further includes the instruction of:
(ii) enabling decentralized downloads of subscription-based content by
(1) allowing the client nodes to subscribe to one or more of the subscription-based content,
(2) periodically sending the subscribed to subscription-based content to each the respective subscribing client nodes, and
(3) charging a fee to providers of the subscription-based content for serving the subscription-based content.

23 The computer-readable medium of claim 21 wherein the content includes free content and fee-based content, instruction(b)(i)(2) further including the instructions of:
1. charging a fee from a provider of the free content for serving the free content, and
2. charging a fee from a user receiving the fee-based content.

24 The computer-readable medium of claim 22 wherein the subscription-based content includes free content and fee-based content, instruction (b)(ii)(3) further including the instruction of: charging a fee from consumers 16 of the subscribing client nodes for receiving the fee-based content.

25 The computer-readable medium of claim 14 further including the step of implementing the marketplace as a website.

26 The computer-readable medium of claim 14 further including the step of implementing the marketplace as a peer-to-peer network.

27 The computer-readable medium of claim 26 further including the instruction of:
(d) allowing consumers to become affiliates of the marketplace where the unused bandwidth of the consumer's computers is used to deliver the files to other consumers, and paying the affiliates of the network as an incentive for donating bandwidth to the network.

28 The computer-readable medium of claim 27 furthering including the step of paying the affiliates for referring new consumers to the network.

29 A system for providing a digital file marketplace comprising:
means for allowing content owners to share their digital files on the marketplace for access by consumers;
means for generating revenue by charging the consumers fees for receiving or opening the digital files; and
means paying a percentage of the revenue to the content owners as royalties.

30 The system of claim 29 wherein the means for paying royalties further includes calculating a royalty pool over a predetermined period of time, and calculating the royalty payment for each content owner by dividing the royalty pool by a number of content owners participating during the predetermined time period based on actual consumption of the owner's content on the network.

31 The system of claim 30 wherein the means for paying royalties further includes deducting bandwidth fees charged to each content owner for delivery of the content over the network from the royalty payment.

32 The system of claim 31 wherein the means for paying royalties further includes providing the content owners with a choice of receiving their royalty payment as a credit charged to a credit card account, or as a check mailed to an address of record.

33 The system of claim 30 wherein the royalty pool is calculated on one of a daily, weekly, and monthly basis.

34 The system of claim 30 wherein consumption is defined as at least one of a number of content files delivered, a total size of the content delivered, and money per content file paid for the content by consumers 16.

35 The system of claim 29 wherein the network includes at least one server node and multiple client nodes, and peer-to-peer file sharing of content is enabled by initiating on one client node a download of a particular content item served from the server node or another client node, and charging a fee based on a quantity of the content served.

36 The system of claim 35 wherein the means for generating revenue includes enabling decentralized downloads of subscription-based content by
(1) allowing the client nodes to subscribe to one or more of the subscription-based content,
(2) periodically sending the subscribed to subscription-based content to each the respective subscribing client nodes, and
(3) charging a fee to providers of the subscription-based content for serving the subscription-based content.

37 The system of claim 35 wherein the content includes free content and fee-based content, and wherein a fee is charged to a provider of the free content for serving the free content, and a fee is charge to a user receiving the fee-based content.

38 The system of claim 36 wherein the subscription-based content includes free content and fee-based content, and wherein a fee is charged to consumers 16 of the subscribing client nodes for receiving the fee-based content.

39 The system of claim 29 further including the step of implementing the marketplace as a website.

40 The system of claim 29 further including the step of implementing the marketplace as a peer-to-peer network.

41 The system of claim 40 further including means for allowing consumers to become affiliates of the marketplace where the unused bandwidth of the consumer's computers is used to deliver the files to other consumers, and paying the affiliates of the network as an incentive for donating bandwidth to the network.
